(19) United States
(12) Patent Application Publication
(10) Pub. No.: US 2018/0193962 A1
(43) Pub. Date: Jul. 12, 2018

(54) COMPOSITION FOR BRAZING, TUBE FOR HEAT EXCHANGERS, AND HEAT EXCHANGER

(71) Applicants: HARIMA CHEMICALS, INC., Hyogo (JP); KEIHIN THERMAL TECHNOLOGY CORPORATION, Tochigi (JP)

(72) Inventors: Atsuhiro OGURA, Hyogo (JP); Tomoaki AKAZAWA, Hyogo (JP); Kazuyuki OKAZAKI, Tochigi (JP); Yohei IKAWA, Tochigi (JP)

(73) Assignees: HARIMA CHEMICALS, INC., Hyogo (JP); KEIHIN THERMAL TECHNOLOGY CORPORATION, Tochigi (JP)

(21) Appl. No.: 15/741,966

(22) PCT Filed: Mar. 4, 2016
(86) PCT No.: PCT/JP2016/056750

§ 371 Date: Jan. 4, 2018

(30) Foreign Application Priority Data
Jul. 6, 2015 (JP) 2015-135414

(51) Int. Cl. B23K 35/362; F28F 19/06; F28F 21/08; F28F 1/00; B23K 1/00

(52) U.S. Cl. CPC B23K 35/362; F28F 19/06; F28F 2275/04; F28F 1/00; B23K 1/0012; F28F 21/08

(57) ABSTRACT

Provided is a composition for brazing containing a flux, a Zn metal powder, a (meth) acrylic resin, and an organic solvent, in which the organic solvent contains (A1) a monohydric alcohol having 1 to 5 carbon atoms; (A2) a monohydric alcohol having 6 to 8 carbon atoms; and (A3) a polyhydric alcohol having 3 or less carbon atoms that are bonded by a carbon-carbon bond.

### TECHNICAL FIELD

An embodiment of the present invention relates to a composition for brazing having excellent productivity and application stability.

### BACKGROUND ART

Conventionally, members made of aluminum or aluminum alloys are used, for example, for automotive aluminum heat exchangers represented by an evaporator, a condenser, and the like to be mounted in vehicles. At the time of brazing these members, fluxes for brazing or mixtures (compositions for brazing) of fluxes, brazing fillers (metals), and binder resins are used. These fluxes or mixtures are applied to brazing portions and thereafter, assembling process and heating are carried out to perform a brazing work.

A cover layer made of Zn (zinc) is formed on a surface of a heat exchanger tube used in a heat exchanger in order to improve corrosion resistance. Such a cover layer is formed by using Zn-containing fluxes or Zn powders as brazing fillers. Zn, however, has a significantly large specific gravity, so that while a composition for brazing containing Zn powders is stored, the Zn powders are settled. This causes difference in concentration between the Zn powders, failing to uniformly apply the composition for brazing to a surface of the heat exchanger tube.

In order to solve such a problem, for example, Patent Document 1 proposes a nonaqueous zinc flux paint containing flux including zinc fluoride; (meta)acrylic resin; alcoholic solvent; and at least one anti-settling agent selected from the group consisting of aliphatic polyols having 3 to 6 carbon atoms, oligomers of aliphatic polyols having 2 to 3 carbon atoms, monoesters having 3 to 7 carbon atoms comprising aliphatic polyols and aliphatic carboxylic acids, and polymers of aliphatic polyols having a weight average molecular weight of 1,000 or less.

Since the nonaqueous zinc flux paint disclosed in Patent Document 1 is capable of inhibiting the occurrence of sediment such as fluxes or metal powders, it has excellent storage stability.

Such nonaqueous zinc flux paint, however, needs to fix fluxes and metal powders after applied to the surface of the member. Therefore, the nonaqueous zinc flux paint should be kept for a certain period of time in a temperature range in which the solvent evaporates, resulting in lower productivity. In order to improve the productivity, it is required to improve dryness of the composition for brazing. In addition, in order to form a uniform Zn cover layer, more uniform application of the composition for brazing (application stability) is required.

### PRIOR ART DOCUMENT

### Patent Document

Patent Document 1: Japanese Unexamined Patent Publication No. 2013-107104

### SUMMARY OF THE INVENTION

### Problems to be Solved by the Invention

The problem according to an embodiment of the present invention is to provide a composition for brazing having excellent productivity and application stability.

### Means for Solving the Problems

The composition for brazing according to an embodiment of the present invention contains a flux, a Zn metal powder, a (meth)acrylic resin, and an organic solvent, in which the organic solvent contains (A1) a monohydric alcohol having 1 to 5 carbon atoms; (A2) a monohydric alcohol having 6 to 8 carbon atoms; and (A3) a polyhydric alcohol having 3 or less carbon atoms that are bonded by a carbon-carbon bond.

The heat exchanger tube according to an embodiment of the present invention includes a tube body and a cover layer formed of the above-mentioned composition for brazing on an outer surface of the tube body.

The heat exchanger according to an embodiment of the present invention includes the above-mentioned heat exchanger tube.

### Effect of the Invention

The composition for brazing according to an embodiment of the present invention has excellent productivity and application stability. Therefore, when the composition for brazing according to an embodiment of the present invention is used, for example, as a raw material of the cover layer formed into a heat exchanger tube, a heat exchanger tube can be effectively manufactured and a uniform cover layer can be formed.

### PREFERRED EMBODIMENTS FOR CARRYING OUT THE INVENTION

The composition for brazing according to one embodiment of the present invention contains a flux, a Zn metal powder, a (meth)acrylic resin, and an organic solvent. Each of the components will be described hereinbelow in detail. As referred to herein, “(meth)acrylic” means “acrylic” or “methacrylic”, and “(meth)acrylate” means “acrylate” or “methacrylate”.

### Flux

The flux contained in the composition for brazing according to the one embodiment of the present invention is used to remove oxide films. Examples of the flux include potassium fluoroaluminate, potassium fluoride, aluminum fluoride, lithium fluoride, sodium fluoride, potassium fluoroaluminate-cesium complex (non-reactive cesium type flux), cesium fluoroaluminate (non-reactive cesium type flux), potassium fluorozincate (reactive zinc-substituted flux), and cesium fluorozincate (reactive zinc-substituted flux).

The flux is contained at a ratio ranging from preferably 5 to 32% by mass, more preferably from 10 to 30% by mass, in the composition for brazing. In the case where the flux is contained at such a ratio, the oxide films can be effectively removed. The fluxes may be used alone or in combination of two or more kinds.

### Zn Metal Powder

The Zn metal powder contained in the composition for brazing according to the one embodiment of the present invention is melted by heating during brazing, so that a Zn diffusion layer is formed on the applied surface. As a result, corrosion resistance can be improved. The Zn metal powder is not particularly limited and, for example, a Zn metal powder having an average particle size ranging from 2 to 5 μm, preferably from 3 to 4 μm is used. The average particle size is measured using, for example, a “laser diffraction scattering type particle size analyzer MT3000II” manufactured by Nikkiso Co., Ltd.

The Zn metal powder is contained at a ratio ranging from preferably 5 to 32% by mass, more preferably from 10 to 30% by mass, in the composition for brazing. In the case where the Zn metal powder is contained at such a ratio, the Zn diffusion layer is easily formed with a uniform and sufficient thickness, which allows further improvement of corrosion resistance.

### (Meth) Acrylic Resin

The (meth) acrylic resin contained in the composition for brazing according to the one embodiment of the present invention serves as a binder and is used for uniform adherence of the composition for brazing. The (meth) acrylic resin is a polymer produced by polymerizing (meth) acrylic compounds such as acrylic acid, methacrylic acid, and (meth) acrylate.

Examples of the (meth)acrylate include methyl (meth) acrylate, ethyl (meth) acrylate, hydroxyethyl (meth)acrylate, butyl (meth)acrylate, 2-ethylhexyl (meth)acrylate, 2,2-dimethyllauryl (meth)acrylate, 2,3-dimethyllauryl (meth)acrylate, 2,2-dimethylstearyl (meth) acrylate, 2,3-dimethylstearyl (meth) acrylate, isolauryl (meth)acrylate, isomyristyl (meth)acrylate, isostearyl (meth)acrylate, and isobehenyl (meth)acrylate.

The (meth)acrylic resin may be a homopolymer of a (meth)acrylic compound or a copolymer comprising two or more kinds of (meth)acrylic compounds. Alternatively, it may be a copolymer comprising a (meth)acrylic compound and another monomer which is copolymerizable with the (meth)acrylic compound. Examples of the other monomer include acrylamide and styrene. The other monomer is set to less than 50% by mole in the monomer component constituting the copolymer.

The weight average molecular weight of the (meth)acrylic resin is not particularly limited, and is in the range of preferably 10,000 to 600,000, more preferably 50,000 to 500,000. The weight average molecular weight is a value converted based on polystyrene by gel permeation chromatography. The weight average molecular weight of the (meth)acrylic resin can be appropriately set by adjusting the blending amount of a radical polymerization initiator or a chain transfer.

The (meth)acrylic resin has an acid value (measurement method: in conformity with JIS K 2501) of preferably 0 to 65 mg KOH/g, more preferably 15 to 40 mg KOH/g, without being limited thereto. The acid value thereof is prepared, for example, with the content of acrylic acid, methacrylic acid, or the like.

A method for synthesizing the (meth) acrylic resin is not particularly limited and a known method is adopted. For example, the monomer component constituting the (meth) acrylic resin may be subjected to radical polymerization using a solvent, a polymerization initiator, a chain transfer, or the like as required. The polymerization initiator used for the radical polymerization is not particularly limited as long as it is a compound that decomposes to generate radicals. Examples of the polymerization initiator include azo type initiators and peroxide type initiators. In the case of using a solvent, for example, at least one of the organic solvents to be described later may be used. The use of the organic solvent to be described later allows such organic solvent to be used as is without removing the solvent.

The (meth)acrylic resin is contained at a ratio ranging from preferably 0.5 to 15% by mass, more preferably from 3 to 10% by mass, in the composition for brazing. In the case where the (meth)acrylic resin is contained at such a ratio, the composition for brazing can be more uniformly adhered. The (meth) acrylic resins may be used alone or in combination of two or more kinds.

### Organic Solvent

The organic solvent contained in the composition for brazing according to the one embodiment of the present invention contains the following (A1), (A2), and (A3) components.

(A1) Monohydric alcohol having 1 to 5 carbon atoms

(A2) Monohydric alcohol having 6 to 8 carbon atoms

(A3) Polyhydric alcohol having 3 or less carbon atoms that are bonded by a carbon-carbon bond.

Among the organic solvents, the (A1) component is used in terms of dryness and compatibility with the other components. That is, by containing the (A1) component having a relatively low boiling point in the composition for brazing, the organic solvent tends to evaporate to thereby improve dryness. In addition to alcohols, organic solvents having a low boiling point are available, but such organic solvents have poor compatibility with the other components. Further, organic solvents having excessively low boiling points deteriorate application stability and productivity because of an excessively high evaporation rate.

Specific examples of the (A1) component include methyl alcohol, ethyl alcohol, n-propyl alcohol, isopropyl alcohol, n-butyl alcohol, isobutyl alcohol, sec-butyl alcohol, tert-butyl alcohol, 3-methoxy-1-butanol, ethylene glycol monomethyl ether (methylcellosolve), ethylene glycol monoethyl ether (ethylcellosolve), diethylene glycol methyl ether (methyl carbitol), propylene glycol monomethyl ether, and propylene glycol monoethyl ether. Of these, monohydric alcohol having 5 carbon atoms is preferable, 3-methoxy-1-butanol is more preferable.

The (A1) component is contained at a ratio ranging from preferably from 1 to 83.5% by mass in the composition for brazing. The (A1) components may be used alone or in combination of two or more kinds.

Among the organic solvents, the (A2) component is used in terms of ensuring uniformity after application. Specific examples of the (A2) component include ethylene glycol monobutyl ether (buthylcellosolve), diethylene glycol ethyl ether (ethyl carbitol), diethylene glycol butyl ether (butyl carbitol), propylene glycol monobutyl ether, dipropylene glycol monomethyl ether, dipropylene glycol monoethyl ether, and 3-methoxy-3-methyl-1-butanol. Of these, 3-methoxy-3-methyl-1-butanol is preferable.

The (A2) component is contained at a ratio ranging from preferably from 1 to 83.5% by mass in the composition for brazing. The (A2) components may be used alone or in combination of two or more kinds.

Among the organic solvents, the (A3) component is used in terms of prevention of settling of the Zn metal powder or the like. As compared with the case of using a polyhydric alcohol other than the (A3) component (e.g., hexylene glycol, etc.), using the (A3) component can more effectively prevent settling of Zn metal powder or the like. Examples of the (A3) component include the following (A31) and (A32) components.

(A31) component: A compound having 3 or less carbon atoms and having at least 2 hydroxyl groups in its molecule

(A32) component: A compound in which a hydrocarbon unit having 3 or less carbon atoms is bonded in a plural number through a heteroatom (oxygen atom, etc.) and having at least 2 hydroxyl groups in its molecule.

Specific examples of the (A31) component include ethylene glycol, propylene glycol, trimethylene glycol, and glycerin. Specific examples of the (A32) component include polyols in which at least one of oxyethylene and oxypropylene is bonded in a plural number, for example, diethylene glycol, triethylene glycol, and dipropylene glycol.

Of the (A3) components, (A31) component is preferable, propylene glycol is more preferable. The (A3) component is contained at a ratio ranging from preferably 5 to 20% by mass, more preferably from 10 to 15% by mass, in the composition for brazing. The (A3) components may be used alone or in combination of two or more kinds.

As the organic solvent contained in the composition for brazing according to the one embodiment of the present invention, the blending ratio of the (A1), (A2), and (A3) components is not particularly limited as long as these three components are contained. For example, the (A1) and (A2) components are contained at amass ratio ((A1)/(A2)) in the range of preferably 0.25 to 4 in terms of improving productivity and application stability. In addition, the (A1) and (A3) components may be contained at amass ratio ((A1)/(A3)) in the range of preferably 0.2 to 4.

### Composition For Brazing

The composition for brazing according to the one embodiment of the present invention is produced by mixing the flux, Zn metal powder, (meth) acrylic resin, and organic solvent described above and stirring the mixture. The mixing and stirring methods are not particularly limited and the components may be stirred so as to be uniformly mixed by a known method.

The composition for brazing according to the one embodiment of the present invention may optionally contain various additives as long as the effect of the composition for brazing according to the one embodiment of the present invention is not impaired. Examples of such an additive include antioxidants (dibutylhydroxytoluene, etc.), corrosion inhibitors (benzotriazole, etc.), antifoaming agents (silicone oil, etc.), thickening agents (wax, hydrogenated oil, fatty acid amide, polyamide, etc.), coloring agents, and amino alcohols. For example, addition of a thickening agent allows for further improvement in storage stability, sagging prevention properties, and brazing performance of the composition for brazing.

The composition for brazing according to the one embodiment of the present invention is prepared so as to have a solid content concentration in the range of, for example, 15 to 85% by mass, preferably 30 to 70% by mass, more preferably 45 to 60% by mass. The solid content concentration may be adjusted, for example, by the amount of the organic solvent used. Further, the composition for brazing according to the one embodiment of the present invention is prepared so as to have a viscosity (25° C.) in the range of, for example, 50 to 1000 mPa·s , preferably 100 to 600 mPa·s, considering workability or the like. The viscosity is measured using an “E-type viscometer (100 rpm/1°34′ cone)” manufactured by Toki Sangyo Co., Ltd.

The thus obtained composition for brazing according to the one embodiment of the present invention has excellent productivity and application stability. Therefore, when the composition for brazing is used, for example, as a raw material of the cover layer formed into a heat exchanger tube, a heat exchanger tube can be effectively manufactured and a uniform cover layer can be formed. The heat exchanger tube may have the composition for brazing according to the one embodiment of the present invention applied thereto so that, for example, a cover layer having a thickness of 2 to 10 μm is formed on the outer surface of the tube body. A heat exchanger including such a heat exchanger tube is suitably mounted, for example, in vehicles such as automobiles.

### EXAMPLES

The one embodiment of the present invention will be specifically described hereinbelow by illustration of Examples and Comparative Examples, without intending to limit an embodiment of the present invention to these examples.

### Example 1

The following components were mixed at the following ratios, and the mixture was sufficiently stirred to produce a composition for brazing. As the methacrylic resin, a resin derived from NHM-SW71-15MMB (manufactured by Harima Chemicals, Inc.) was used. As the flux, FL-7SS (manufactured by Morita Chemical Industries Co., Ltd.) was used.

Methacrylic resin: 8.9% by mass

Flux: 23.6% by mass

Zn metal powder: 23.6% by mass

3-methoxy-3-methyl-1-butanol: 20.3% by mass

3-methoxy-1-butanol: 8.6% by mass

Propylene glycol: 15% by mass

### Examples 2 to 16 and Comparative Examples 1 to 5

A composition for brazing was produced in the same manner as in Example 1, except that the components listed in Tables 1 and 2 were mixed at the ratio listed in Tables 1 and 2.

### Evaluation

The compositions for brazing obtained in Examples 1 to 16 and Comparative Examples 1 to 5 were evaluated in terms of (1) application stability, (2) Zn diffusion, (3) productivity, and (4) brazing performance. The results are shown in Tables 1 and 2. In the case where none of (1) to (4) was evaluated as (−), it was judged that the composition for brazing had an excellent effect.

### (1) Application Stability

The composition for brazing was applied to the outer surface of a tube body (length:about 10 cm) of a heat exchanger tube and then dried. After drying, a mass (W₁) of the tube body where a cover layer had been formed was weighed with a precision balance. Next, the cover layer was removed using acetone, and a mass (W₀) of the tube body after removal of the cover layer was weighed. Then, an area (A₁) of the applied surface of the tube body was determined, and the dried amount of application (g/m²) was calculated using the following formula (I). A difference between the dried amount of application thus obtained and a desired dried amount of application (calculated dried amount of application) was determined and evaluated based on the following criteria.

Dried amount of application (g/m²)=(W₁−W₀)/A₁ (I)

++: Difference between the desired dried amount of application and the actual dried amount thereof was less than ±0.5 g/m² and continuous application control was possible.

+: Difference between the desired dried amount of application and the actual dried amount thereof was less than ±1.0 g/m² and continuous application control was possible.

−: Difference between the desired dried amount of application and the actual dried amount thereof was ±1.0 g/m² or more and uneven application occurred.

### (2) Zn Diffusion

The Zn diffusion layer in the cross section of the tube body where the cover layer obtained in evaluation of the application stability had been formed was observed with an electron probe micro-analyzer (EPMA). The Zn diffusion depth was determined, thereby evaluating Zn diffusion based on the following criteria. The deeper the Zn diffusion depth was, the more the Zn diffusion layer was favorably formed, resulting in excellent corrosion resistance.

++: Zn diffusion depth was 100 μm or more.

+: Zn diffusion depth was 50 μm or more and less than 100 μm.

−: Zn diffusion depth was less than 50 μm.

### (3) Productivity

The composition for brazing was applied to the outer surface of a tube body (length:about 10 cm) of a heat exchanger tube in an amount of 5 g/m² and kept at 150° C. for 15 seconds. Then, the applied surface was visually observed, thereby evaluating it based on the following criteria.

++: Completely dried and solidified.

+: Some undried portions existed, but almost solidified.

−: Undried, unsolidified, and peeling of coating occurred.

### (4) Brazing Property

An aluminum member where the composition for brazing was applied was used as a horizontal member (JIS-A1050, 60 mm×25 mm×1.0 mm). On the other hand, a brazing sheet in which a silicon-aluminum alloy (brazing filler) was cladded on an aluminum alloy containing 1.2% by mass of manganese and 2.5% by mass of zinc was used as a vertical member (55 mm×25 mm×0.2 mm). Next, the vertical member was set in an inverted-T shaped form via the composition for brazing and then fixed to the horizontal member using a stainless wire to produce a test piece for evaluation of brazing property. Then, using an atmospheric box type electric furnace (A (V)-BC-M, manufactured by NORITAKE TCF Co., Ltd.), the test piece thus obtained was heated at 605° C. under a nitrogen atmosphere (oxygen concentration: 100 ppm or less) to carry out brazing. The brazed portion was visually observed, thereby evaluating it based on the following criteria. In Comparative Examples 1, 2 and 5, the application stability was found to be poor, so that the brazing property was not evaluated.

++: Complete fillet having a height of 20 mm or more on one side was formed and sufficient joining strength was obtained.

+: Fillet having a height of 10 mm or more and less than 20 mm on one side was formed and general joining strength was obtained.

−: Evaluation for brazing property was not carried out.

TABLE 1

| | | Examples | | | | | | | |
|---|---|---|---|---|---|---|---|---|---|
| | | 1 | 2 | 3 | 4 | 5 | 6 | 7 | 8 |
| Flux | | 23.6 | | | | | | | |
| ZN Metal Powder | | 23.6 | | | | | | | |
| Methacrylic resin | | 8.9 | | | | | | | |
| (A1) | 3-methoxy-1-butanol | 8.6 | 8.6 | 8.6 | — | — | — | 8.6 | 8.6 |
| | 1-methoxy-2-propanol | — | — | — | 8.6 | — | — | — | — |
| | 1-ethoxy-2-propanol | — | — | — | — | 8.6 | — | — | — |
| | Ethanol | — | — | — | — | — | 8.6 | — | — |
| (A2) | 3-methoxy-3-methyl-1-butanol | 20.3 | 20.3 | 20.3 | 20.3 | 20.3 | 20.3 | — | — |
| | Ethylene glycol monobutyl ether | — | — | — | — | — | — | 20.3 | — |
| | Diethylene glycol monobutyl ether | — | — | — | — | — | — | — | 20.3 |
| (A3) | Propylene glycol | 15 | — | — | 15 | 15 | 15 | 15 | 15 |
| | Glycerin | — | 15 | — | — | — | — | — | — |
| | Diethylene glycol | — | — | 15 | — | — | — | — | — |
| (A1)/(A2) | | 0.42 | 0.42 | 0.42 | 0.42 | 0.42 | 0.42 | 0.42 | 0.42 |
| (A1)/(A3) | | 0.57 | 0.57 | 0.57 | 0.57 | 0.57 | 0.57 | 0.57 | 0.57 |
| Application stability | | ++ | + | + | ++ | ++ | ++ | + | + |
| Zn diffusion | | ++ | + | + | + | + | + | + | + |
| Productivity | | ++ | ++ | ++ | + | + | + | ++ | ++ |
| Brazing performance | | ++ | ++ | + | + | + | + | + | + |
| | | Examples | | | | | | | |
| | | 9 | 10 | 11 | 12 | 13 | 14 | 15 | 16 |
| Flux | | 23.6 | | | | | | | |
| ZN Metal Powder | | 23.6 | | | | | | | |
| Methacrylic resin | | 8.9 | | | | | | | |
| (A1) | 3-methoxy-1-butanol | 5.4 | 5.9 | 23.5 | 20.8 | 22.8 | 25.1 | 4.6 | 4.7 |
| | 1-methoxy-2-propanol | — | — | — | — | — | — | — | — |
| | 1-ethoxy-2-propanol | — | — | — | — | — | — | — | — |
| | Ethanol | — | — | — | — | — | — | — | — |
| (A2) | 3-methoxy-3-methyl-1-butanol | 23.5 | 20.8 | 5.4 | 5.4 | 15.7 | 12.5 | 18.6 | 14.4 |
| | Ethylene glycol monobutyl ether | — | — | — | — | — | — | — | — |
| | Diethylene glycol monobutyl ether | — | — | — | — | — | — | — | — |
| (A3) | Propylene glycol | 15 | 17.2 | 15 | 17.7 | 5.4 | 6.3 | 20.7 | 24.8 |
| | Glycerin | — | — | — | — | — | — | — | — |
| | Diethylene glycol | — | — | — | — | — | — | — | — |

| | | | | | | | | |
|---|---|---|---|---|---|---|---|---|
| (A1)/(A2) | 0.23 | 0.28 | 4.35 | 3.85 | 1.45 | 2.01 | 0.25 | 0.33 |
| (A1)/(A3) | 0.36 | 0.34 | 1.57 | 1.18 | 4.22 | 3.98 | 0.22 | 0.19 |
| Application stability | + | ++ | + | ++ | + | ++ | ++ | + |
| Zn diffusion | + | ++ | + | ++ | + | ++ | ++ | + |
| Productivity | ++ | ++ | ++ | ++ | + | ++ | ++ | ++ |
| Brazing performance | + | ++ | + | ++ | + | ++ | ++ | + |

*Each component is valued by mass %.

TABLE 2

| | | Comparative examples | | | | |
|---|---|---|---|---|---|---|
| | | 1 | 2 | 3 | 4 | 5 |
| Flux | | 23.6 | | | | |
| ZN Metal Powder | | 23.6 | | | | |
| Methacrylic resin | | 8.9 | | | | |
| (A1) | 3-methoxy-1-butanol | 28.9 | 14.9 | — | 8.6 | — |
| | 1-methoxy-2-propanol | — | — | — | — | — |
| | 1-ethoxy-2-propanol | — | — | — | — | — |
| | Ethanol | — | — | — | — | — |
| (A2) | 3-methoxy-3-methyl-1- | — | 29 | 28.9 | 20.3 | 20.3 |
| | butanol | | | | | |
| | Ethylene glycol monobutyl | — | — | — | — | — |
| | ether | | | | | |
| | Diethylene glycol monobutyl | — | — | — | — | — |
| | ether | | | | | |
| (A3) | Propylene glycol | 15 | — | 15 | — | 15 |
| | Glycerin | — | — | — | — | — |
| | Diethylene glycol | — | — | — | — | — |

| | | | | | |
|---|---|---|---|---|---|
| Hexylene glycol | — | — | — | 15 | — |
| Acetone | — | — | — | — | 8.6 |
| (A1)/(A2) | — | 0.51 | 0 | 0.42 | 0 |
| (A1)/(A3) | 1.93 | — | 0 | — | 0 |
| Application stability | − | − | + | + | − |
| Zn diffusion | − | − | + | + | − |
| Productivity | ++ | − | − | − | − |
| Brazing performance | − | − | + | + | − |

*Each component is valued by mass %.

It can be seen from Table 1 that the compositions for brazing obtained in Examples 1 to 16 have generally required brazing property and exhibit excellent effects in terms of all of the application stability, the Zn diffusion, and the productivity. On the other hand, it can be seen from Table 2 that the compositions for brazing obtained in Comparative Examples 1 to 5 are evaluated as (−) in terms of at least one of the application stability, the Zn diffusion, and the productivity, having poor effects.

1. A composition for brazing comprising a flux, a Zn metal powder, a (meth)acrylic resin, and an organic solvent,
wherein the organic solvent comprises the following (A1), (A2), and (A3) components:
(A1) Monohydric alcohol having 1 to 5 carbon atoms
(A2) Monohydric alcohol having 6 to 8 carbon atoms
(A3) Polyhydric alcohol having 3 or less carbon atoms that are bonded by a carbon-carbon bond.

2. The composition for brazing according to claim 1, wherein a mass ratio ((A1)/(A2)) of the (A1) and (A2) components is in a range of 0.25 to 4.

3. The composition for brazing according to claim 1, wherein a mass ratio ((A1)/(A3)) of the (A1) and (A3) components is in a range of 0.2 to 4.

4. The composition for brazing according to claim 1, wherein the (A1) component comprises a monohydric alcohol having 5 carbon atoms.

5. The composition for brazing according to claim 1, wherein the (A1) component comprises 3-methoxy-1-butanol.

6. The composition for brazing according to claim 1, wherein the (A2) component comprises 3-methoxy-3-methyl-1-butanol.

7. The composition for brazing according to claim 1, wherein the (A3) component comprises propylene glycol.

8. A heat exchanger tube comprising a tube body and a cover layer formed of the composition for brazing according to claim 1 on an outer surface of the tube body.

9. A heat exchanger comprising the heat exchanger tube defined in claim 8.
